(19) United States
(12) Patent Application Publication
(10) Pub. No.: US 2025/0389296 A1
(43) Pub. Date: Dec. 25, 2025

(54) Agricultural Harvesting Machine

(71) Applicant: PÖTTINGER Landtechnik GmbH, Grieskirchen (AT)

(72) Inventors: Andreas Dietachmair, Grieskirchen (AT); August Greifeneder, Grieskirchen (AT); Markus Reininger, Grieskirchen (AT)

(21) Appl. No.: 19/224,845

(22) Filed: Jun. 1, 2025

(30) Foreign Application Priority Data
Jun. 21, 2024 (DE) 10 2024 117 530.3

(51) Int. Cl. F16C 11/06; A01D 34/00

(52) U.S. Cl. CPC F16C 11/0695; A01D 34/006

(57) ABSTRACT

A suspension and an agricultural harvesting machine, in particular a mower, having a working assembly which is suspended in an oscillating manner by means of the suspension and can be guided over the ground. In the region of an upright axis through the center of gravity of the working assembly, the suspension has a central, articulated bearing head to which the working assembly is fastened. The bearing head has an adjustable bearing bracket for adjusting the bearing head relative to the working assembly in a direction transverse to the upright axis through the center of gravity of the working assembly.

### CROSS-REFERENCE TO RELATED APPLICATIONS

This application claims benefit under 35 USC § 119 of DE Application No. DE 10 2024 117 530.3 filed 21 Jun. 2024, which is incorporated herein by reference in its entirety as if set forth herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### SEQUENCE LISTING

Not Applicable

### STATEMENT REGARDING PRIOR DISCLOSURES BY THE INVENTOR OR A JOINT INVENTOR

Not Applicable

### BACKGROUND OF THE DISCLOSURE

### 1. Field of the Invention

The present invention relates to a suspension and an agricultural harvesting machine, in particular in the form of a mower, comprising a working assembly which is suspended in an oscillating manner by means of the suspension for ground adaptation and can be guided over the ground, wherein the suspension has a central, articulated bearing head in the region of an upright axis through the center of gravity of the working assembly, on which the working assembly is suspended in an oscillating manner.

### 2. Description of Related Art

In agricultural harvesting machines such as mowers, the working assembly, which usually extends transversely to the direction of travel in the working position, should rest as uniformly as possible on the ground over its working width and move as lightly as possible over ground undulations and similar unevenness. In order to achieve such ground adaptation, the working assemblies are usually suspended in an oscillating manner, wherein a central, articulated bearing head is fastened approximately in the center of the working width on the working assembly so that the bearing head comes to rest above the center of gravity of the working assembly. In this case, it is substantially important that the bearing head provided for weight relief is seated approximately centrally above the center of gravity of the working assembly in relation to the working width, i.e., transverse to the direction of travel, while a displacement in the direction of travel is not very disruptive or can be compensated for by further articulation points, for example, by lower links, which hold the working assembly in position against the resistance to travel.

Typically, the bearing head or oscillating suspension has at least one oscillating axis which is aligned horizontally approximately in parallel to the direction of travel, so that the working assembly can oscillate up and down with its end portions protruding to the right and left, wherein the suspension can also often enable overall up and down movements without an oscillating portion in order to enable adjustment in the event of straight bumps. Depending on the suspension, the pendulum head can also have further degrees of freedom or allow pendulum movements around other axes in order to achieve the best possible adaptation to the ground. For example, it can also be helpful to enable a swivel movement about a horizontal axis transverse to the direction of travel for working assemblies with a larger extension in the direction of travel, for example if a conditioner and possibly also a transverse conveyor is attached to the rear of a mower, in order to be able to perform pitching movements for ground adaptation when driving into transversely extending bumps, which can be controlled via additional links if necessary.

However, with such working assemblies suspended in an oscillating manner, there is a problem in that, when lifting into the headland position, the lifted working assembly can unintentionally tilt to one side, particularly if the center of gravity of the working assembly is displaced relative to the central bearing head, or more specifically, if an upright axis through the center of gravity is eccentrically displacement relative to the oscillating axis of the bearing head. Such a displacement of the center of gravity often occurs due to various attachments that can be installed on the working assembly as additional equipment at the customer's request. On mowers, the center of gravity is often not seated exactly in the middle of the mowing width, as various optional equipment can be attached depending on the design, for example, lighting, hydraulic operating aids, protective bars, road transport markings, or also functional assemblies such as tine conditioners, roller conditioners, swath formers, disc mowers, or drum mowers, etc.

One-sided or uneven dirt build-up during operation can also cause the center of gravity to displace the center.

Despite various embodiments and only selectively installed optional equipment, however, a suspension that is as uniform as possible and a machine frame that is designed as uniformly as possible, including various frame parts, should be used for all embodiments in order to achieve lower manufacturing costs and require less storage space through many identical parts and thus higher quantities. At the same time, this makes it easier to convert between different versions. In addition, customers sometimes want to adapt the design of the harvester to conditions during the season, for example by converting from a conditioner to a swath former, which is also made easier by using as many identical parts as possible.

In order to mitigate the resulting problems caused by the displacing center of gravity and the resulting eccentricity towards the oscillating manner of the suspension, it has already been proposed to mount counterweights on the working assembly in order to bring the center of gravity, which has been displaced eccentrically by attachments, back towards the center of the working width. However, such counterweights naturally increase the weight of the working unit, which impairs its ability to adapt easily to the ground. At the same time, the additional weight places greater strain on the components. Irrespective of the above, it is also not easy to precisely balance the position of the center of gravity with such additional weights so that tilted positions of the working unit can actually be avoided when lifting the working unit at the headland.

Therefore, there have also been proposed spring elements to compensate for eccentric positions of the center of gravity. Spring elements can be installed between the mowing or working assembly and the machine frame, on which the mowing or working assembly is suspended in an oscillating manner, which generate a moment around the oscillating axis and in this way can keep the working assembly horizontal in the raised front end position. However, such additional spring elements can also impair the desired oscillating movements during operation, which are required to adapt to the ground and should be as light-footed as possible. Irrespective thereof, such spring elements also cause similar problems as additional weights, as various spring elements are required for various embodiments and different attachment part configurations, which in turn significantly increases the number of components and brackets required.

Therefore, the object of the present invention is to create an improved agricultural mower of type mentioned, which avoids the disadvantages of the prior art and advantageously improves the latter. In particular, even in difficult mowing conditions on inclined slopes with downward or inclined travel, a swath which is narrower than the working width of the mower is to be reliably achieved without disturbing the flow of clippings and a compact, narrow and lightweight construction of possible downstream slave units such as conditioners and transverse conveyors is to be made possible.

### BRIEF SUMMARY OF THE INVENTION

Proceeding from the above, it is the underlying object of the present invention to create an improved agricultural harvesting machine of the type, which avoids disadvantages of the prior art and further develops the latter in an advantageous manner. In particular, a fine balancing of the working assembly in the raised front end position is to be achieved without impairing the ground adaptation, in order to avoid unintentional sideways hanging of the oscillating working assembly in the headland.

According to the invention, an object is achieved by a suspension for an agricultural harvesting machine comprising an articulated bearing head configured to be fastened to a working assembly of an agricultural harvesting machine, wherein the articulated bearing head has an adjustable bearing bracket configured for adjusting the articulated bearing head relative to the working assembly in a direction transverse to an upright axis through a center of gravity of the working assembly.

The adjustable bearing bracket can be further configured to be adjustable transverse to a direction of travel and/or parallel to a working width of the working assembly.

The articulated bearing head can have an oscillating axle, wherein the adjustable bearing bracket is further configured to be adjustable in such a manner that the articulated bearing head and/or the oscillating axle of the articulated bearing head can be brought beyond the center of gravity of the working assembly for various positions of the center of gravity of the working assembly.

For various positions of the center of gravity of the working assembly, the oscillating axle can be brought to a point of intersection with the upright axle through the center of gravity of the working assembly.

According to the invention, another object is achieved by an agricultural harvesting machine, in particular a mower, comprising a working assembly which is suspended in an oscillating manner by means of a suspension and can be guided over the ground, wherein, in the region of an upright axis through the center of gravity of the working assembly, the suspension has a central, articulated bearing head, to which the working assembly is fastened, wherein the bearing head has an adjustable bearing bracket for adjusting the bearing head relative to the working assembly in a direction transverse to the upright axis through the center of gravity of the working assembly.

The previous approach of compensating for an eccentricity of the center of gravity, which can occur due to various design configurations and attachments, by means of compensatory measures such as additional weights or spring elements, is therefore abandoned. Instead, the cause of unwanted inclined positions in the raised front end position is tackled at the root and the articulated bearing head, which enables the oscillating suspension, is brought back into a balanced position relative to the possibly eccentric center of gravity. It is thus deliberately allowed that the center of gravity has an eccentric position and the position of the articulated bearing head is adjusted in order to rebalance the working assembly suspended thereon in an oscillating manner.

According to the invention, the central, articulated bearing head has an adjustable bearing bracket for adjusting the bearing head relative to the working assembly in a direction transverse to the upright axis through the center of gravity of the working assembly. If the position of the center of gravity of the working assembly is displaced from the center, for example due to additional optional equipment such as lighting or road safety elements or other functional components, the position of the bearing head can be adjusted relative to the working assembly by the adjustable bearing bracket so that the oscillating axis of the bearing head can be brought back beyond the displaced center of gravity, in particular in such a way that the oscillating axis can intersect the upright axis through the center of gravity of the working assembly. Depending on the setup status and/or attached additional parts, the adjustable bearing bracket can be adjusted appropriately in order to bring the oscillating axis back above the center of gravity, which may have been displaced, and thereby avoid unwanted inclined positions in the raised front end position.

The adjustability of the articulated bearing head transverse to the oscillating axis and transverse to the upright axis through the center of gravity can not only be used to balance the working assembly in the raised front end position, but can also be helpful if the working assembly has to travel at an angle on slopes, so that a uniform ground contact over the total working width requires a deliberate eccentricity of the bearing head towards the center of the working width in order to compensate for the inclined alignment of the working assembly when driving on slopes or to enable uniform contact forces towards both ends of the working width.

In a further development of the invention, the adjustable bearing bracket can be configured to be adjustable at least transverse to the direction of travel in order to be able to adjust the bearing head relative to the working assembly transverse to the direction of travel. Such transverse adjustability transverse to the direction of travel is particularly helpful if the bearing head for the working assembly provides an oscillating axis that extends horizontally, approximately in parallel to the direction of travel. If the working assembly's center of gravity becomes eccentric transverse to the direction of travel, for example because an additionally attached assembly has more weight on the left-hand side, the oscillating axis can be displaced back beyond the center of gravity.

If necessary, the adjustable bearing bracket can also be configured to be adjustable in other directions, in particular in a direction approximately in parallel with the direction of travel, which can be helpful in the case of heavy additional attachment units such as a conditioner and/or a cross conveyor, which are attached to the rear of a mower, for example, and noticeably displace the center of gravity to the rear in the direction of travel. By adjusting the bearing head in the direction of travel, the ground contact force can also be equalized in the direction of travel.

In particular, the adjustable bearing bracket can be adjusted in such a manner that the bearing head or its oscillating axis can be brought beyond the center of gravity and/or the oscillating axis realized by the bearing head can be brought to an intersection point with an upright axis by the pivot point for different center of gravity positions of the working assembly, at least when the working assembly assumes a balanced neutral position. Depending on the suspension, the upright axis may be displaced by the center of gravity and the bearing head when the working assembly performs soil contact movements, wherein in this case the adjustable bearing bracket can be used to set an intersection point between the oscillating axis and the upright center of gravity axis, in particular when the working assembly assumes a neutral initial or working position that has not yet been deflected.

In particular, the adjustable bearing bracket can comprise a sliding guide by means of which the bearing head can be moved relative to the working assembly transverse to the direction of travel and/or transverse to the oscillating axis and/or transverse to the upright axis through the center of gravity. The adjustment position set via the sliding guide can be fixed by a fixing device. In this case, the sliding guide can have plain bearings or also rolling bearings between two bracket or frame parts that can be moved relative to each other in order to enable easy movement.

For example, such a sliding guide can have an elongated hole in the bearing bracket and/or in a frame part of the working assembly to be connected to it, in which elongated hole one or more fixing bolts can be provided, which block the adjustability along the elongated hole when tightened and enable displacement along the elongated hole when loosened.

In principle, however, it would also be possible to realize the adjustability of the bearing bracket, for example, by means of a hole pattern comprising several bolt holes arranged next to each other, so that the desired adjustment can be achieved by repositioning the fixing bolt and moving the bearing bracket accordingly.

However, in order to enable more convenient operation, the adjustable bearing bracket can also be assigned an actuator for applying an adjustment force and for adjusting the articulated bearing head relative to the working assembly. Such an actuator can be a spindle drive or a screw spindle, for example, which can affect the adjustment in the desired adjustment direction by means of a screw movement. Such a screw spindle can, for example, be configured to be self-locking in order to hold the sliding guide position once it has been set.

In a further development of the invention, the actuator can also be configured to be motorized, for example comprising an electric spindle drive and/or a pressure medium cylinder for motorized adjustment of the bearing head relative to the working assembly.

If such a motorized actuation of the adjustment is provided, the adjustment of the position of the bearing head can be set automatically in dependence on a setup status of the harvesters and/or a sensor signal of a sensor system for detecting the center of gravity position and/or an operating parameter of the machine operation.

In this case, the adjustment can be semi-automatic or fully automatic. For example, a machine operator can be retrieved via a selection menu which additional equipment or functional units have been attached or generally which attachment the working assembly has been equipped with. Depending on the setup status information entered by the machine operator, an electronic control device, which may be equipped with a processor, a working memory and a program memory, can then adjust the bearing head relative to the working assembly in dependence on the respective setup status, in which the positioning actuator is controlled accordingly by the control device.

Alternatively or additionally, the respective setup status can be detected automatically with the aid of a sensor system, for example by reading a transponder mounted on the respective item of equipment by a reader of the control device, so that the control device detects the setup status in this way.

Alternatively or additionally, a sensor system can also detect the actual position of the working assembly's center of gravity relative to the oscillating axis of the bearing head, for example by using an inclination sensor or another sensor such as an optical sensor to detect an undesired inclination or tilt of the working assembly in the raised front end position. The control device can then readjust or adjust the position of the bearing head relative to the working assembly in dependence on the sensor signal until the working assembly hangs in the desired, balanced position in the headland.

Such sensor system detection of the actual center of gravity can also be particularly helpful in order to be able to compensate for one-sided dirt build-up during operation and the resulting shifts in the center of gravity by adjusting the bearing bracket.

Alternatively, or additionally, when adjusting the position of the bearing head relative to the working assembly, the control device can also take into account operating parameters that take into account the use of the machine in the field. For example, an inclination sensor can be used to detect the hill slope or the inclination of the suspension of the harvester in relation to the horizontal or vertical, in order to then adjust the position of the bearing head in relation to the working assembly in dependence on the detected inclination. In this manner, for example, the bearing head can also be moved back and forth relative to the working assembly when driving back and forth on slopes, where the left side of the machine is the downhill side and the right side of the machine is the downhill side, in order to achieve a uniformly high ground contact force across the width of the machine on various hill slopes.

Alternatively, or additionally, the ground contact force can also be detected by a sensor system on a right-hand side of the machine and a left-hand side of the machine during working operation in order to then adjust the bearing head by the control device in dependence on the detected ground contact force and to equalize the ground contact force in this manner.

Alternatively, or additionally, the control device can also be configured to take into account cornering and/or cornering radii and/or centrifugal forces or lateral accelerations arising during cornering and, depending on the variables, adjust the position of the bearing head relative to the working assembly in order to compensate for the centrifugal forces acting on the working assembly or to avoid an unwanted inclination of the working assembly as a result of centrifugal forces. For example, a transverse acceleration sensor can provide a transverse acceleration signal, in dependence on which the control device controls the actuator and adjusts the position of the bearing head. Alternatively, or additionally, a longitudinal signal from a tractor can also be fed to the control device and taken into account by it in order to adjust the bearing head.

In a further development of the invention, the central, articulated bearing head of the suspension can be part of a multiple link suspension or be mounted on a link which can, for example, pivot up and down about a horizontal link axis in order to enable overall height movements of the working assembly, wherein such height pivoting movements of the link can be used for soil contact movements of the working assembly, but can also be used for lifting the working assembly into the front end position. Such a link can be fastened to a headstock, for example, which can be used to attach the harvester to a tractor.

For example, the central, articulated bearing head can be part of a three-point linkage, which can be realized with the aid of an upper link and two lower links, which are each hinged to the working assembly and can be fastened with their other ends, for example, to the headstock in an articulated manner. In this case, relief devices such as weight relief springs or pressure cylinders can act on one or more of the links in order to relieve the weight of the working assembly during operation and thus achieve a light-footed adaptation to the ground. Alternatively or additionally, an actuator can also be connected to such a link suspension in order to enable lifting via the front end position, wherein such an actuator does not have to act directly on one of the links, but can also act, for example, on the bearing head and/or on a pivot point on the working assembly, and on the other hand can be connected to the pivot point on the headstock or another frame part. The same also applies to the previously the relief springs or relief cylinders.

These and other objects, features and advantages of the present invention will become more apparent upon reading the following specification in conjunction with the accompanying drawing figures.

### BRIEF DESCRIPTION OF THE DRAWINGS

The accompanying Figures, which are incorporated in and constitute a part of this specification, illustrate several aspects described below.

FIG. 1 is a perspective view of an agricultural harvesting machine in the form of a mower which is suspended in an oscillating manner from a central, articulated bearing head, wherein the bearing head is shown in a central neutral position.

FIG. 2 is a plan view of the machine on its suspension from FIG. 1.

FIG. 3 is a front view of the harvester from the preceding figures.

FIG. 4 is a rear view of the harvester from the preceding figures, showing a lateral oscillating movement of the working assembly, for example with the center of gravity eccentric in the raised front end position.

FIG. 5 is a front view of the harvester similar to FIG. 3, wherein the central bearing head is no longer centered, but is displaced to the right side (to the left side when viewed in the direction of travel).

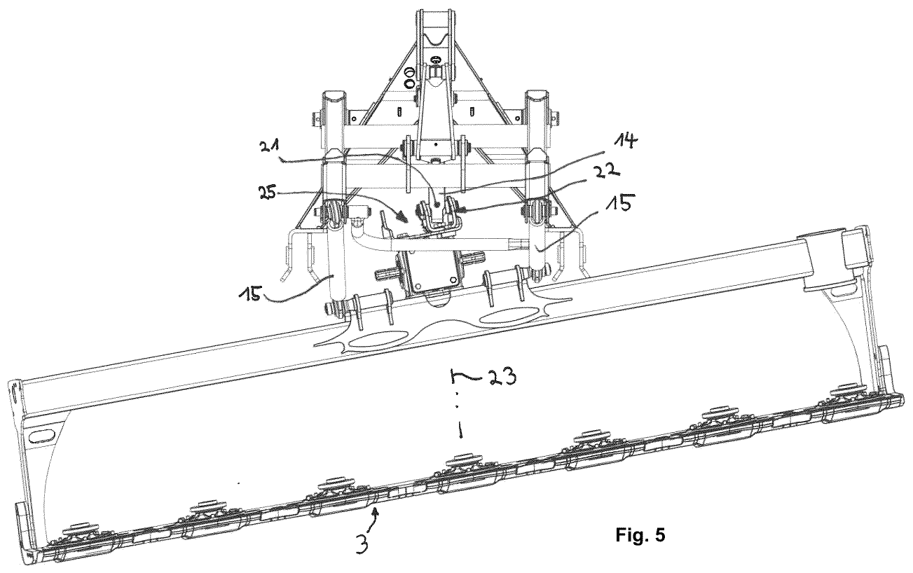

FIG. 6 is a rear view of the harvester, showing the adjustment of the bearing head as shown in FIG. 5 from the rear perspective.

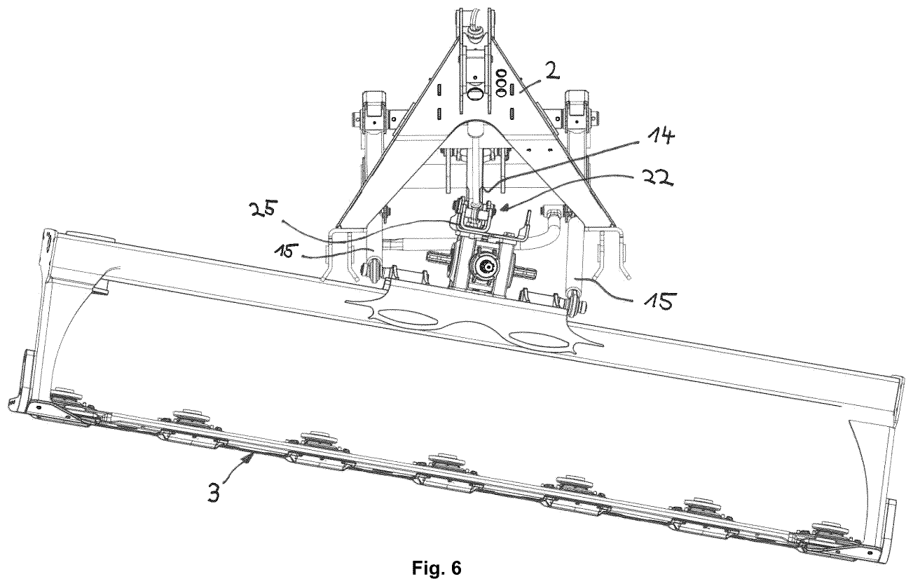

FIG. 7 is a sectional perspective view showing the adjustable bearing bracket in a position displaced to the right.

FIG. 8 is a perspective view of the bearing bracket from FIG. 7 in a position displaced in the opposite direction to the left.

FIG. 9 is a perspective view of the adjustable bearing bracket, wherein the actuator shown is a screw bolt for displacing the position of the bearing bracket.

FIG. 10 is a plan view of the harvester similar to FIG. 2, wherein, unlike FIG. 2, the bearing bracket is shown in a position adjusted to the left according to the direction of travel.

FIG. 11 is a front view of the harvester from the previous figures, wherein, in addition to the mower, a cross conveyor comprising two spiral-shaped profiled cross conveyor shafts is attached, which can displace the center of gravity.

FIG. 12 is a front view of the harvester from the previous figures, wherein a conditioner with rotationally rotating conditioning elements is attached as an additional unit.

FIG. 13 is a rear view of the harvester from the preceding figures, wherein relief springs for weight relief of the working assembly are attached to the articulation points of the lower links.

### DETAIL DESCRIPTION OF THE INVENTION

To facilitate an understanding of the principles and features of the various embodiments of the invention, various illustrative embodiments are explained below. Although exemplary embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the exemplary embodiments, specific terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

As the figures show, the agricultural harvesting machine 1 can be configured as a mower, for example in the form of a front-mounted mower, which can be attached to a tractor not shown via a headstock 2. However, the harvester can also be configured as a rear-mounted device and, for example, have a machine frame supported on the ground, from which the actual working assembly can then protrude transversely, for example in the form of a rear-mounted mower.

However, the harvester 1 could also be configured differently, for example in the form of a mower or a haymaking machine in the form of a counter or a rotary swather, with which the crop horizontally lying on the ground can be gathered into a swath.

Irrespective of the specific design of the harvester 1, its working assembly 3 can have a horizontal orientation at least in the working position and extend with its working width transverse to the direction of travel 4. For example, as shown in the figures, the working assembly 3 of the harvester 1 configured as a mower may comprise a cutter bar with cutting blades arranged side by side and rotationally driven about an upright axis, wherein the mower could also be configured in the form of a drum mower with rotationally driven cutting blade drums.

As the figures show, the working assembly 3 can be fastened to a support frame 5, which can extend transversely across the working width. With the support frame 5, the working assembly is suspended by a suspension 6 which guides the working assembly 3 over the ground and allows the working assembly 3 to perform soil contact movements. In this case, the suspension 6 is preferably configured to be weight-relieving, so that the working assembly 3 does not rest on the ground with its full weight, but can only rest on the ground with a fraction thereof or with a desired contact force, which is preferably uniformly distributed over the working width.

In this case, the suspension 6 can comprise a link arrangement 7, which connects the support frame 5 to the headstock 2 and permits a lifting movement, with the aid of which the working assembly 3 can be lifted from the working position on the ground into a front end position and/or road transport position. If the harvester 1 is designed as a front mower or generally as an implement that can be mounted on the front of the tractor, it can be lifted horizontally into the headland position and also into the transport position.

This also applies to rear-mounted harvesters whose working width is small enough to allow road transport without pivoting.

In the case of rear-mounted mowers or harvesters with laterally protruding working assemblies, a front end position can also be started up with the working assembly 3 in a horizontal position, for example, while the working assembly 3 can usually be pivoted into an upright transport position for road transport.

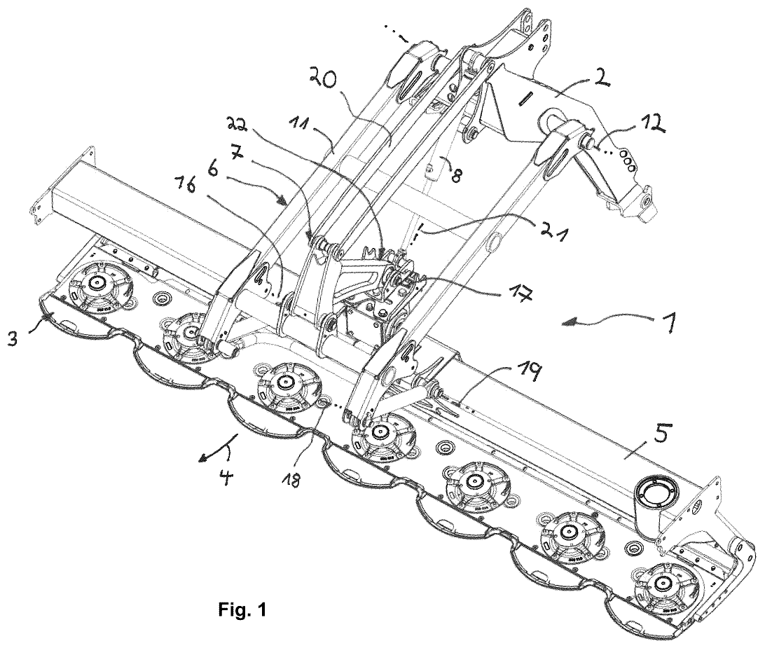

As FIG. 1 shows, for example, the link arrangement 7 can be assigned a pressure medium cylinder 8, which can be hinged to the headstock 2 on the one hand and hinged to one of the link arms of the link arrangement 7 or a suspension part connected to it or the support frame 5 on the other hand, in order to be able to lift the working assembly 3 into the front end position and possibly also into the transport position under the control of the kinematics of the link arrangement 7. In this respect, the pressure medium cylinder 8 can form a lifting device or lifting drive.

Equally, the pressure medium cylinder 8 can also serve to relieve the weight in the working position and, for example, be pressurized with limited pressure from a pressure accumulator.

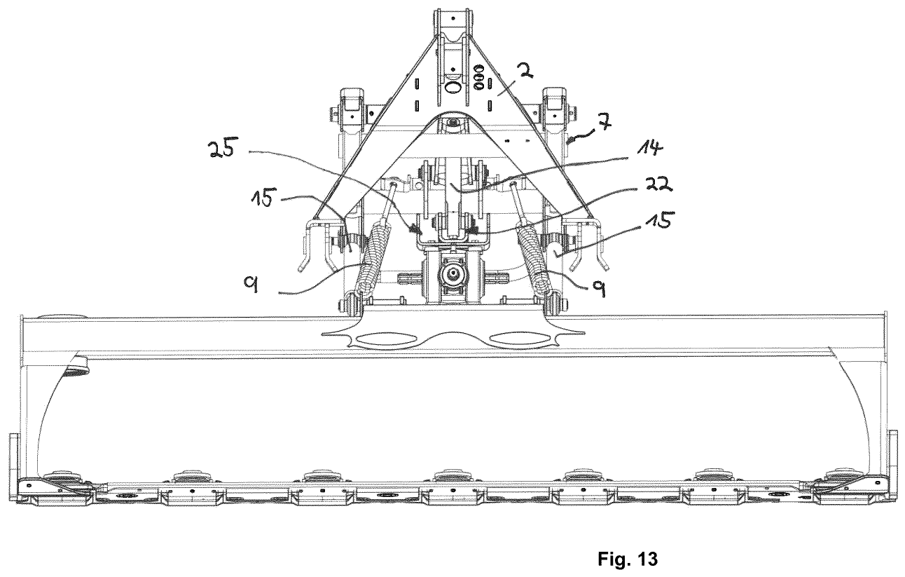

Alternatively, or in addition to such a pressure medium cylinder 8, however, weight relief in the working position can also be achieved by relief springs 9, which can be provided, for example, between two link arms of the link arrangement 7 or a portion of the link arrangement 7 and the support frame 5, cf. FIG. 13. For example, a pair of relief springs 9 can engage on the support frame 5 in the area of the articulation point of lower links 15 or also on the lower links 15 themselves and hingedly tension the support frame 5 upwards relative to a section of the handlebars hinged to the headstock 2 in order to achieve weight relief, cf. FIG. 13.

As the figures show, the steering arrangement 7 can have a steering yoke 11 or a support frame protruding from the headstock 2, which can pivot on the headstock 2 about a horizontal pivot axis 12, so that the total link arrangement 7 can move up and down, either to adapt to the ground when driving over bumps or to lift it into the front end position. The working assembly 3 can be suspended from the steering yoke 11 or the support frame formed by it, in particular from a protruding end portion thereof, by means of a multiple link arrangement 13, which can, for example, comprise an upper link 14 and two lower links 15, each of which can be pivotally hinged to the steering yoke 11 about pivot axes 16 and 17, respectively, on the one hand, and pivotally hinged to the support frame 5 about pivot axes 18, 19, on the other hand. The pivot axes 16-19 can extend horizontally, in particular transverse to the direction of travel 4. The same can apply to the aforementioned pivot axis 12, about which the steering yoke 11 can be luffed up and down.

As the figures show, the steering yoke 11 on the one hand and the upper and lower links 14, 15 can extend in opposite directions with respect to the direction of travel 4 or form an acute-angled triangle. In particular, the steering yoke 11 can protrude forward from the headstock 2 in the direction of travel, in particular in the working position at an acute angle to the horizontal at an oblique downward angle to the front. On the other hand, the upper and lower links 14, 15 can extend back from the protruding end portion of the steering yoke 11 in the opposite direction to the direction of travel, in particular at an acute angle to the horizontal, splayed obliquely downwards to the rear.

As FIG. 1 illustrates, one of the upper or lower links, in particular the upper link 14, can be positively controlled by a coupling link 20 when the steering yoke 11 swings up and down in order to keep the working assembly 3 in a desired alignment when the link arrangement 7 moves up and down, namely with respect to an axis horizontally transverse to the direction of travel and/or in parallel to the longitudinal extension of the working assembly 3.

In addition to the described axes of movement of the link arrangement 7, the working assembly 3 can oscillate relative to the link arrangement, namely about an oscillating axis 21, which can extend horizontally, approximately parallel to the direction of travel, so that left and right end portions of the working assembly 3 can rock upwards and downwards, respectively, in order to be able to adjust to transverse waves or to be able to tilt when starting up laterally against splayed surfaces.

In particular, the working assembly 3 can be suspended from a central, articulated bearing head 22, which is arranged in the area of a perpendicular axis 23 through the center of gravity of the working assembly 3.

The bearing head 22 can form the connection between the upper link 14 and the support frame 5 and can, for example, be configured in the form of a ball joint or a universal joint, wherein, depending on the design of the suspension 6, a single-axis joint with a joint axis in parallel to the oscillating axis 21 can also be provided, for example. However, if several links, in particular the upper and lower links 14 and 15, are provided, the bearing head 22 can be configured with multi-axis articulation and the articulation points of the other links, in particular the lower link 15, can also be multi-axis articulated, since the kinematics of the link suspension can then be used to control the oscillating movement or stabilize the working assembly 3 with respect to undesired oscillating or tilting movements.

As mentioned, the working assembly 3 can oscillate via the bearing head 22, in particular about an oscillating axis 21 parallel to the direction of travel.

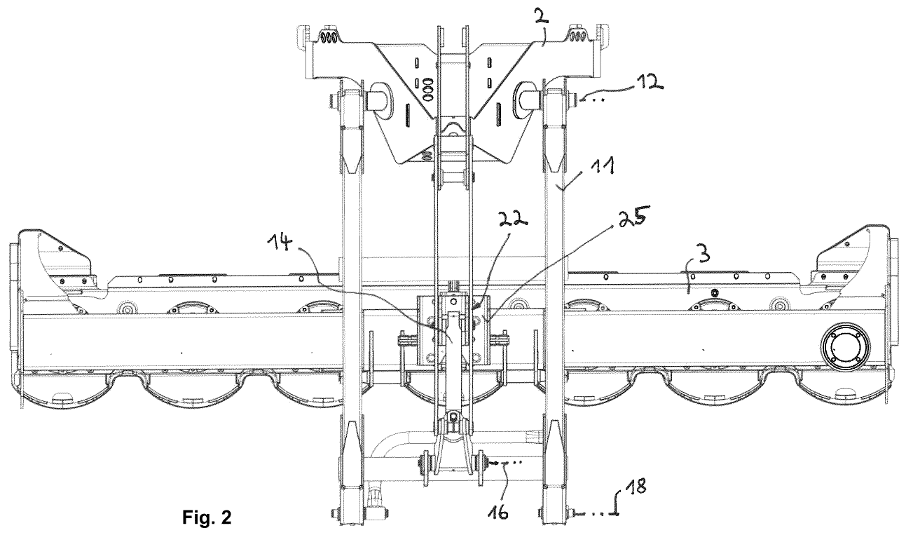

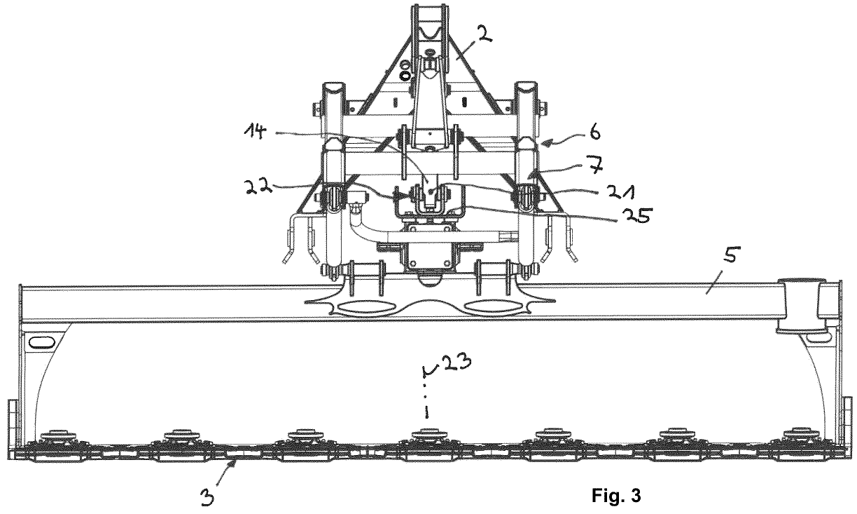

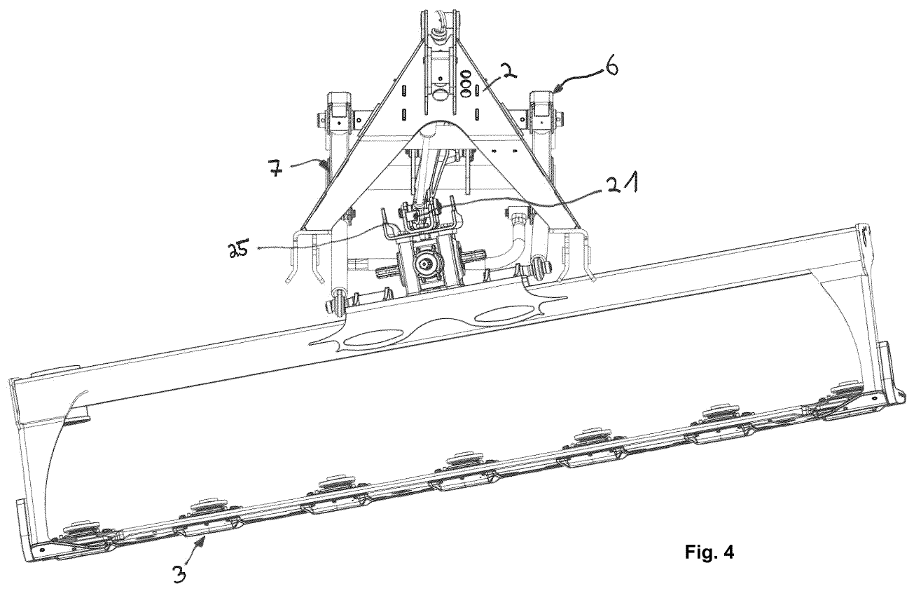

However, if the working assembly 3 is increased from the ground by raising the link arrangement 7 and lifted into the front end position, undesirable tilting of the working assembly 3 about the oscillating axis 21 may occur if the center of gravity of the working assembly 3 is no longer exactly below the oscillating axis 21 or centrifugal forces also act on the working assembly 3 during cornering, for example. As FIGS. 1 to 4 show, the bearing head 22 itself-normally in the neutral position-is arranged centrally in relation to the working width of the working assembly 3, but this only fits if the center of gravity of the working assembly 3 is also centrally in relation to the working width. However, if additional units with eccentric weight distribution are attached, for example additional units with driving apparatus on one side, the working assembly 3 sinks on one side in the raised front end position, cf. FIG. 4.

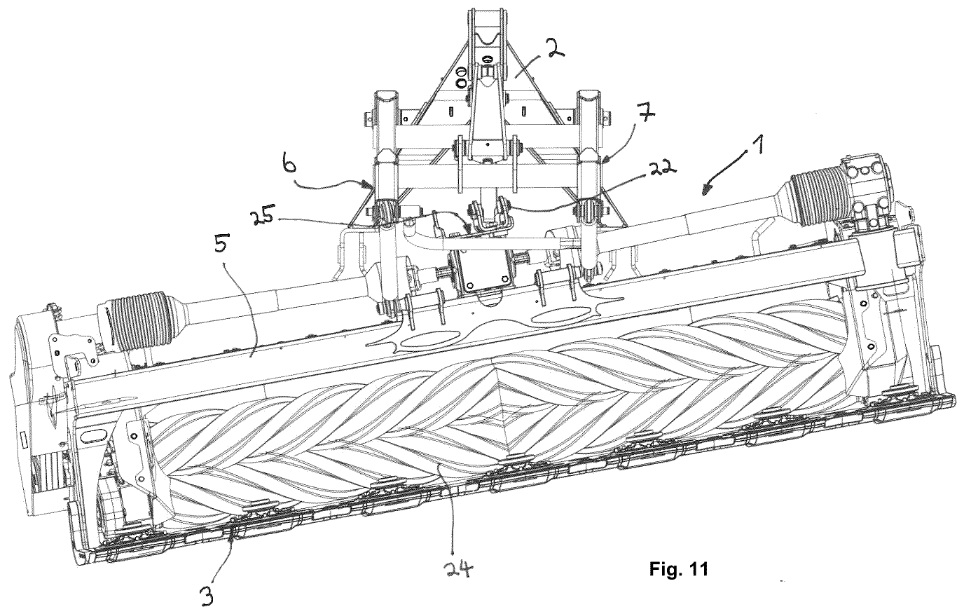

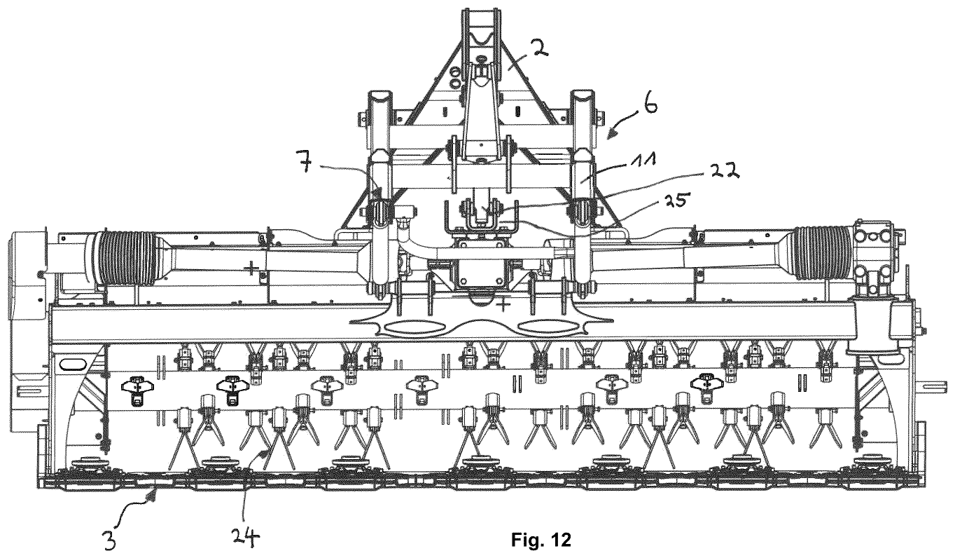

Such additional attachments or units can be, for example, a cross conveyor and/or conditioner 24, cf. FIG. 11 and FIG. 12, which can be attached to the rear of the mowing unit, cf. FIG. 11 and FIG. 12.

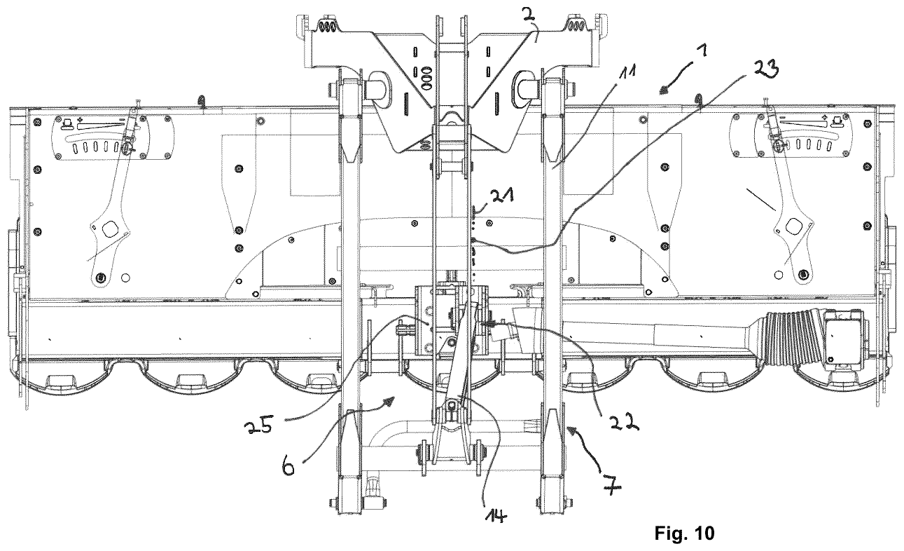

Even if such additional assemblies are usually arranged symmetrically towards the center of the working assembly 3 or extend symmetrically to the right and left, an eccentric weight distribution can still occur, for example if the driving apparatus is guided towards an end portion of the additional assembly, cf. comparing FIG. 10 and FIGS. 11, 12, according to which an additional drive train can be guided to one side by an additional assembly and a transmission can be provided there.

In order to be able to compensate for any resulting displacements of the center of gravity, the bearing head 22 can be displaced relative to the working assembly 3, namely in a direction transverse to the oscillating axis 21 and transverse to the upright axis 23 through the center of gravity of the working assembly 3, in order to, so to speak, get the oscillating axis 21 back beyond the eccentrically displaced center of gravity.

As shown in the figures, the bearing head 22 can have an adjustable bearing bracket 25, which has an adjustability in the direction transverse to the oscillating axis 21 and transverse to the upright center of gravity axis 13. The bearing bracket 25 can be part of the articulated bearing head 22 or connect the bearing head 22 or its articulated part to the support frame 5.

In this case, the bearing bracket 25 may itself comprise two bracket parts 26, 27 which are displaceable relative to one another and which can be adjusted relative to one another in the direction, preferably by means of a sliding guide 28 which has a sliding guide axis transverse to the oscillating axis 21 of the bearing head 22 and transverse to the upright axis 23 through the center of gravity.

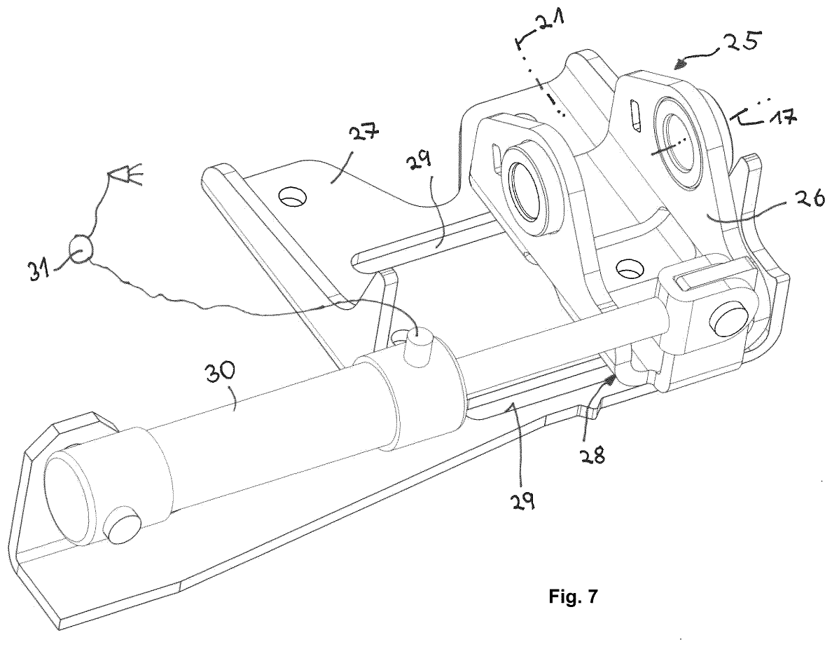

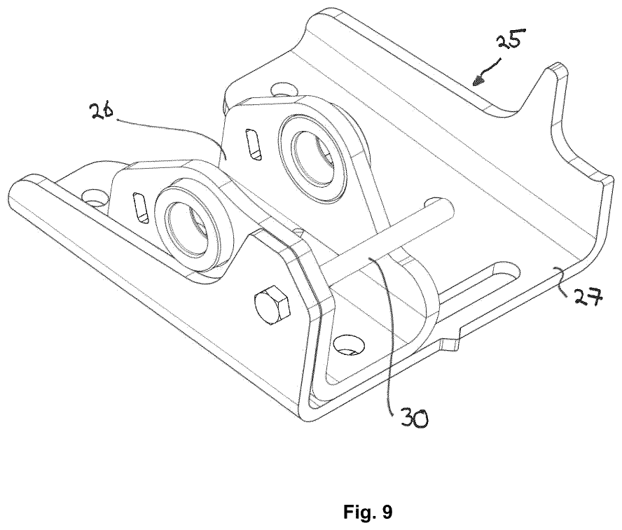

As shown in FIGS. 7, 8 and 9, the two bracket parts 26, 27 can be mounted so that they can slide relative to one another by the sliding guide 28 and can be connected to one another, wherein, for example, one bracket part 27 can have one or more elongated holes 29 in which the other bracket part 26 can be guided, for example by means of pins or screw connections. However, the sliding guide 28 can also be configured differently, for example comprising a dovetail groove in which a T-shaped or V-shaped spread guide key can run. Alternatively, or additionally, a guide rod can also be provided on one bracket part, on which the other bracket part can run with a hole.

The two bracket parts 26, 27 can form separate components, wherein one bracket part 26 can be fastened to the bearing head 22 or hinged to the upper link 14 of the link arrangement 7, whilst the other bracket part 27 can be fastened to the support frame 5, for example welded or bolted there. Alternatively, however, it would also be possible to form one of the bracket parts 27 integrally and integrally on the support frame 5 of the working assembly 3 or to form a portion of the support frame 5 as a bracket part.

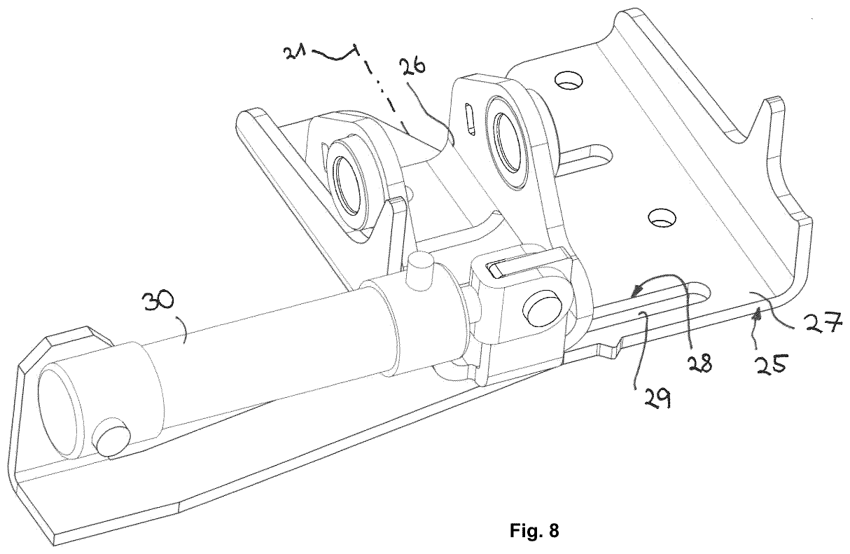

As shown in FIGS. 7 and 8, the bearing bracket 25 can advantageously be adjusted by a motorized actuator 30, for example in the form of a hydraulic cylinder, wherein the actuator 30 can move the two bracket parts 26, 27 towards each other along the sliding guide 28.

Such an actuator 30 can be controlled by an electronic control device 31 in dependence on various parameters and the bearing bracket 25 can be adjusted as a result, as already explained in detail at the beginning. If the actuator 30 is a hydraulic cylinder, the control device comprises pressure circuit control means such as valves, flow regulators and the like, which are controlled by the electronic control device 31 in order to adjust the hydraulic cylinder 30 in the desired manner

Alternatively, however, a screw spindle or a screw bolt can also be provided between the two bracket parts 26, 27 in order to achieve the desired displacement or adjustment, cf. FIG. 8.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

What is claimed is:

1. A suspension for an agricultural harvesting machine comprising:
an articulated bearing head configured to be fastened to a working assembly of an agricultural harvesting machine;
wherein the articulated bearing head has an adjustable bearing bracket configured for adjusting the articulated bearing head relative to the working assembly in a direction transverse to an upright axis through a center of gravity of the working assembly.

2. The suspension of claim 1, wherein the adjustable bearing bracket is further configured to be adjustable transverse to a direction of travel and/or parallel to a working width of the working assembly.

3. The suspension of claim 1, wherein the articulated bearing head has oscillating axle;
wherein the adjustable bearing bracket is further configured to be adjustable in such a manner that the articulated bearing head and/or the oscillating axle of the articulated bearing head can be brought beyond the center of gravity of the working assembly for various positions of the center of gravity of the working assembly.

4. The suspension of claim 3, wherein, for various positions of the center of gravity of the working assembly, the oscillating axle can be brought to a point of intersection with the upright axle through the center of gravity of the working assembly.

5. An agricultural harvesting machine comprising:
a working assembly; and
the pension of claim 1;
wherein:
the working assembly is suspended in an oscillating manner by means of the suspension and can be guided over the ground; and
the articulated bearing head is fastened to the working assembly in the region of the upright axis through the center of gravity of the working assembly.

6. The agricultural harvesting machine of claim 5, wherein at least one of:
the adjustable bearing bracket is further configured to be adjustable transverse to a direction of travel and/or parallel to a working width of the working assembly;
the articulated bearing head comprises has oscillating axle;
the adjustable bearing bracket is further configured to be adjustable in such a manner that the articulated bearing head and/or the oscillating axle of the articulated bearing head can be brought beyond the center of gravity of the working assembly for various positions of the center of gravity of the working assembly; or
for various positions of the center of gravity of the working assembly, the oscillating axle can be brought to a point of intersection with the upright axle through the center of gravity of the working assembly.

7. The agricultural harvesting machine of claim 6, wherein:
the adjustable bearing bracket comprises a sliding guide for displacing the articulated bearing head transverse to the oscillating axis and transverse to the upright axis through the center of gravity of the working assembly; and
a fixing device is provided for fixing the sliding guide in various displacement positions.

8. The agricultural harvesting machine of claim 6, wherein an actuator is provided for adjusting the adjustable bearing bracket.

9. The agricultural harvesting machine of claim 8, wherein the actuator is configured as a motor.

10. The agricultural harvesting machine of claim 9, wherein the motor comprises a pressure medium cylinder or a spindle drive.

11. The agricultural harvesting machine of claim 6, wherein a control device is provided for adjusting the adjustable bearing bracket in dependence on a setup state signal.

12. The agricultural harvesting machine of claim 11, wherein the setup state signal is generated by a setup state sensor system or is input by a setup state input means.

13. The agricultural harvesting machine of claim 6, wherein a control device is provided for adjusting the adjustable bearing bracket in dependence on a sensor signal of a sensor system which characterizes an eccentric displacement of the center of gravity of the working assembly and/or an inclination of the working assembly in a raised front end position.

14. The agricultural harvesting machine of claim 6, wherein a control device is provided for adjusting the adjustable bearing bracket in dependence on at least one machine operating parameter comprising at least one hill slope transverse to the direction of travel.

15. The agricultural harvesting machine of claim 6, wherein a control device is provided for adjusting the adjustable bearing bracket in dependence on a sensor signal of a sensor system which characterizes cornering and/or a centrifugal force occurring during a cornering and/or a steering angle.

16. The agricultural harvesting machine of claim 6, wherein the articulated bearing head is part of a link arrangement of the suspension which, in addition to the oscillating movement about the oscillating axis, provides for further soil contact movements about other axes of movement.

17. The agricultural harvesting machine of claim 16, wherein the link arrangement comprises an upper link and two lower links, to which the working assembly is hinged by means of three articulation points.

18. The agricultural harvesting machine of claim 17, wherein:
the articulated bearing head forms the articulation point of the upper link on the working assembly; and
the adjustable bearing bracket is adjustable transverse to the longitudinal axis of the upper link and displaces the upper link articulation point transverse to the longitudinal axis of the upper link relative to the working assembly.

19. The agricultural harvesting machine of claim 17, wherein the upper and lower links are hinged to and suspended from a support frame that can be luffed up and down about a horizontal pivot axis on a headstock.

20. The agricultural harvesting machine of claim 19, wherein the support frame is formed by a steering yoke on a protruding end portion of which the upper and lower links are hinged.

21. The agricultural harvesting machine of claim 19, wherein the upper and lower links are mounted at their articulation points so as to be pivotable about pivot axes that are aligned in parallel with the pivot axis of the support frame on the headstock and/or extend horizontally transverse to the direction of travel.
